(19) United States
(12) Patent Application Publication
(10) Pub. No.: US 2025/0285474 A1
(43) Pub. Date: Sep. 11, 2025

(54) METHOD OF DIAGNOSING BEARING FLAKING OF VEHICLE AND PREDICTING REMAINING LIFETIME

(71) Applicants: HYUNDAI MOTOR COMPANY, SEOUL (KR); KIA CORPORATION, SEOUL (KR)

(72) Inventors: Jae-Min Jin, Hwaseong-si (KR); In-Soo Jung, Hwaseong-si (KR)

(73) Assignees: HYUNDAI MOTOR COMPANY, SEOUL (KR); KIA CORPORATION, SEOUL (KR)

(21) Appl. No.: 18/944,828

(22) Filed: Nov. 12, 2024

(30) Foreign Application Priority Data
Mar. 7, 2024 (KR) 10-2024-0032783

(51) Int. Cl. G07C 5/00; B60R 16/023; G01M 13/045; G07C 5/04

(52) U.S. Cl. CPC G07C 5/006; G01M 13/045; G07C 5/04; B60R 16/0231

(57) ABSTRACT

A method of diagnosing bearing flaking of a vehicle and predicting a remaining lifetime applies an index calculated through any one of a test condition of an initial assembly inspection of the electric powertrain, an operating condition of an development durability test, and a constant speed condition of an actual road driving test to warnings of flaking a bearing, an inspection/repair, and an occurrence time prediction. Therefore, occurrence of flaking for the electric powertrain can be prepared using any one of the disassembly inspection in the initial assembly inspection, the test stop and inspection in the development durability test, and the repair or the prediction of occurrence time point in the actual road test.

### CROSS REFERENCE TO RELATED APPLICATIONS

This application claims priority to Korean Patent Application No. 10-2024-0032783, filed on Mar. 7, 2024, which is incorporated herein by reference in its entirety.

### BACKGROUND

### Field of Present Disclosure

Exemplary embodiments of the present disclosure relate to damage to a bearing, which is a mechanical element of an electric powertrain, and more particularly, to a method of diagnosing flaking, which is a mechanical defect of the bearing that generates a vibration and a noise in a vehicle, and predicting a remaining lifetime.

### Description of Related Art

Generally, a bearing race of a bearing corresponds to a surface of a rolling element to gradually cause flaking as the period of use increases, and the flaking may cause problems in the rolling element which generates excessive heat, pressure, and friction.

The flaking bearing may be a problem, especially, in electric vehicles, because the bearing is applied as an important mechanical element to a driving motor and a reducer in the electric powertrain (i.e., ePT), which is a power transmission system of the electric vehicle.

For example, the driving motor generates a driving force using power stored in a battery, the reducer converts a rotation of the driving motor into a rotation speed of a driving shaft of a vehicle through a gear ratio, and the bearing serves to fix the driving shaft, which is rotating, at a predetermined position, support its own weight and a load applied to the driving shaft, and rotates the driving shaft.

Therefore, flaking which is a mechanical defect of the bearing causing a vibration and a noise may occur in electric vehicles.

Thus, drivers have inconvenience of detecting abnormality based on their subjective judgment when a vibration occurs in the vehicle during driving and then taking the vehicle to a service center/maintenance shop to inspect the bearing.

### SUMMARY

Since an electric powertrain may operate normally for a long period of time even when bearing flaking occurs, which is a mechanical defect, and this leads to a situation where a driver continues to drive without being aware of a vibration and a noise, there is a problem in that damage to driving parts occurs due to damage to bearings (e.g. ball bearings) to lead to secondary damage.

In particular, the mechanical defect of bearing flaking may lead to an accident due to damage to the bearing as a normal driving is possible for a long period of time, and a problem cannot be detected using the existing on-board diagnostics (OBD) function so that the problem detection inevitably relies on the judgment of highly skilled mechanics at service centers/maintenance shops.

In addition, even when a bearing is a new product, bearing flaking may occur on an inner or outer race due to a problem in a process. For the new bearing assembled in this state, a flaking size increases for a short period of time, and thus there is a very high probability of causing a vehicle problem.

Moreover, in the case of electric vehicles such as rental cars or shared vehicles, since there is no knowledge of the history of problems of the electric powertrain during the vehicle is traveling, it is impossible to determine whether a current level of the vehicle is normal, and this causes differences in a timing of vehicle service/maintenance due to differences in subjective level evaluation, causing flaking to eventually progress to damage, resulting in large repair costs. In particular, when damage occurs during high-speed driving due to neglect, a probability of serious danger cannot be ruled out.

An embodiment of the present disclosure is directed to providing a method of diagnosing bearing flaking of a vehicle and predicting remaining lifetime, which can determine whether flaking occurs in a bearing of a reducer through modulation analysis of a vibration signal using a vibration of the reducer and a motor rotation speed, in particular, predict a degradation tendency for a future bearing condition by modeling a flaking occurrence index according to the modulation analysis as a change in a vehicle mileage-based index value.

Other objects and advantages of the present disclosure can be understood by the following description and become apparent with reference to the embodiments of the present disclosure. Also, it is obvious to those skilled in the art to which the present disclosure pertains that the objects and advantages of the present disclosure can be realized by the means as claimed and combinations thereof.

In accordance with an embodiment of the present disclosure, there is provided a method of diagnosing bearing flaking of a vehicle and predicting remaining lifetime, and in an initial assembly inspection of the electric powertrain (1) with the acceleration sensor attached thereto, the method includes setting a target revolutions per minute (RPM) (N_{target}) and a target torque (Torq_{target}) for driving the electric powertrain (1) (S2a), when the RPM (N_{target}) and the target torque (Torq_{target}) for driving the electric powertrain are constant, measuring vibration amplitude data, the RPM (N_{target}), and the target torque (Torq_{target}) from the acceleration sensor for a predetermined measurement time, and calculating the variability-based index (S2d), wherein the index is calculated using an equation related to an excitation frequency (fₘₒₜ), which is one rotation frequency of the motor and the vibration amplitude data:

$$Index = \frac{1}{4} \text{?} Maximum ( Amplitud \text{?} ( \text{?} \times 0.9 {f}_{mot} \leq f \leq \text{?} \times 1.1 {f}_{mot} ) )$$

$$\text{?} \text{indicates text missing or illegible when filed}$$

In addition, in an initial assembly inspection of the electric powertrain with the acceleration sensor attached thereto, the method may include setting one or more of a target RPM (N_{target}(i)), a target torque (Torq_{target}(i)), and a target time (T_{test_target}(i)) as an operating condition for driving the electric powertrain, when the target RPM and the target torque are constant, checking the target time (T_{test_target}(i)) and confirming that an operating time (Tₒₚₑᵣₐₜₑ) is less than the target time ((T_{test_target}(i)), extracting data with a 50% overlap at intervals of a predetermined measurement time, and calculating a variability-based index from the extracted target RPM (N_{target}), the extracted target torque (Torq_{target}), and the extracted vibration amplitude data, wherein the index is calculated using an equation related to an excitation frequency (fₘₒₜ), which is one rotation frequency of the motor and the vibration amplitude data:

$$Index = \frac{1}{4} \text{?} Maximum ( Amplitud \text{?} ( \text{?} \times 0.9 {f}_{mot} \leq f \leq \text{?} \times 1.1 {f}_{mot} ) )$$

$$\text{?} \text{indicates text missing or illegible when filed}$$

In addition, the method of diagnosing bearing flaking of a vehicle and predicting a remaining lifetime while a vehicle with an electric powertrain with the acceleration sensor attached thereto is traveling, which may include storing controller area network (CAN) data and vibration amplitude data from an acceleration sensor while the vehicle is traveling, extracting a constant speed condition during driving from the CAN data, calculating a variability-based index for the constant speed condition from revolutions per minute (RPM) of a motor and the vibration amplitude data on the basis of a mileage, and diagnosing a bearing flaking occurrence in real time using thresholds 1 and 2 (Threshold_1 and Threshold_2) for the index, wherein the index is calculated using an equation related to an excitation frequency (fₘₒₜ), which is one rotation frequency of the motor and the vibration amplitude data:

$$Index = \frac{1}{4} \text{?} Maximum ( Amplitud \text{?} ( \text{?} \times 0.9 {f}_{mot} \leq f \leq \text{?} \times 1.1 {f}_{mot} ) ) .$$

$$\text{?} \text{indicates text missing or illegible when filed}$$

In addition, the CAN data may include one or more of a vehicle speed, an accelerator pedal depression, the RPM of the motor, a motor torque, the mileage, and acceleration data.

In addition, in a constant speed driving, the average vehicle speed (V_mean) within a predetermined range may be maintained during a constant speed driving time (T_{drive}), an indicated torque may be greater than or equal to an entry mode minimum torque average (Torq_min) to the constant speed condition, a vehicle speed pedal depression (APS) may be greater than zero, and data may be read using a time-window reading method in which data is acquired based on a predetermined time.

In addition, when the constant speed driving is determined, the average vehicle speed V_mean may be divided into average vehicle speed cases (i) for sections of consecutive vehicle speeds (V1, V2, . . . , and Vi); and the index for each of the average vehicle speed cases (i) may be calculated.

In addition, the diagnosing of the bearing flaking occurrence in real time may be performed when the number of average vehicle speed cases (i) exceeds M.

In addition, when the number of an average vehicle speed case (i) for each section of vehicle speeds (V1, V2, . . . , and Vi) exceeds M, and a 50% overlap is present between the sample data constituting the constant speed driving vehicle speed condition for each section of the vehicle speeds (V1, V2, . . . , and Vi) among M, a sample data index (index_sample_data) for an average vehicle speed case (i) for each section of the M vehicle speeds (V1, V2, . . . , and Vi) may be

$$index\_sample \_data = \frac{1}{M} {\sum }_{i = 1}^{M} ( case ( i ) ) .$$

A trend equation for a model index index_model may be calculated from the several sample data indexes index_sample_data and the mileage (Odometer) for the sample data, and

$${Index}_{model} = {Ae}^{b \times Odometer} .$$

A and b may be calculated from several sample data indexes index_sample_data and the mileage (Odometer) for the sample data.

In addition, A and b of the model index Index_{model} may be updated or refreshed by a new sample data index new index_sample_data as the mileage (Odometer) increases.

In addition, in the thresholds 1 and 2 (Threshold_1, Threshold_2), a mileage-based flaking occurrence prediction (Threshold_1) and a mileage-based flaking occurrence confirmation (Threshold_2) may be applied to the indexes; when the threshold 1 is out of the mileage-based flaking occurrence prediction (Threshold_1), an indicate warning sign for the flaking occurrence may be generated in the vehicle, and when the threshold 2 is out of the mileage-based flaking occurrence confirmation (Threshold_2), an indicate repair sign for the electric powertrain may be generated in the vehicle.

### BRIEF DESCRIPTION OF THE FIGURES

FIGS. 1A, 1B, and 1C are flowcharts illustrating a method of diagnosing bearing flaking of a vehicle and predicting remaining lifetime for an electric powertrain according to the present disclosure.

FIG. 2 is a diagram illustrating a structure of an electric powertrain for diagnosing bearing flaking to which the present disclosure is applied.

FIG. 3A is a block diagram illustrating a process of analyzing a vibration modulation according to the present disclosure.

FIG. 3B is a diagram illustrating a vibration amplitude shown as a modulated signal over time.

FIGS. 4A and 4B are change diagrams according to a modulation frequency for each flaking state in the present disclosure.

FIG. 4C is a diagram illustrating an index of a driving motor.

FIG. 5 is a flowchart illustrating an initial assembly inspection of the electric powertrain according to the present disclosure.

FIG. 6 is a diagram illustrating an index distribution state which is the result of the initial assembly inspection according to the present disclosure.

FIG. 7 is a flowchart illustrating a development durability test of the electric powertrain according to the present disclosure.

FIG. 8 is a diagram illustrating an index trend state which is the result of the development durability test according to the present disclosure.

FIG. 9 is a block diagram illustrating a configuration of a bearing flaking system linked to a vehicle according to the present disclosure.

FIG. 10 is a flowchart illustrating a real-road driving test of the electric powertrain according to the present disclosure.

FIG. 11 is a diagram illustrating an example of estimating a flaking occurrence point and predicting a lifetime of a bearing using a predictive model according to data changes of an index movement average value according to the present disclosure.

### DETAILED DESCRIPTION

Exemplary embodiments of the present disclosure will be described below in more detail with reference to the accompanying drawings, and these embodiments are examples of the present disclosure and may be embodied in various other different forms by those skilled in the art to which the present disclosure pertains so that the present disclosure is not limited to these embodiments.

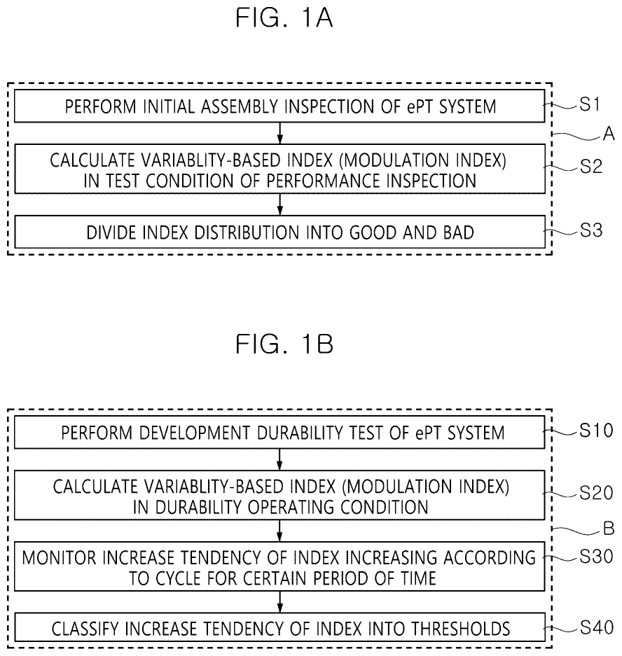

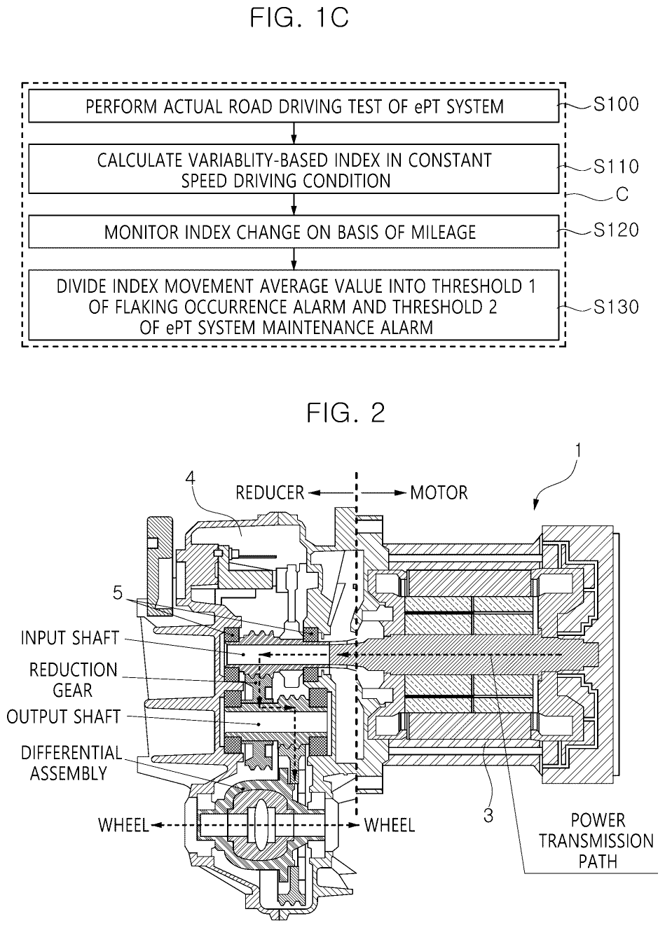

Referring to FIG. 1, a method of diagnosing bearing flaking of a vehicle and predicting remaining lifetime may be implemented by an initial assembly inspection (S1) shown in FIG. 1A, which is a first process A for an electric powertrain, a development durability test (S10) shown in FIG. 1B, which is a second process B, and data acquired in an actual road driving test (S100) shown in FIG. 1C, which is a third process C.

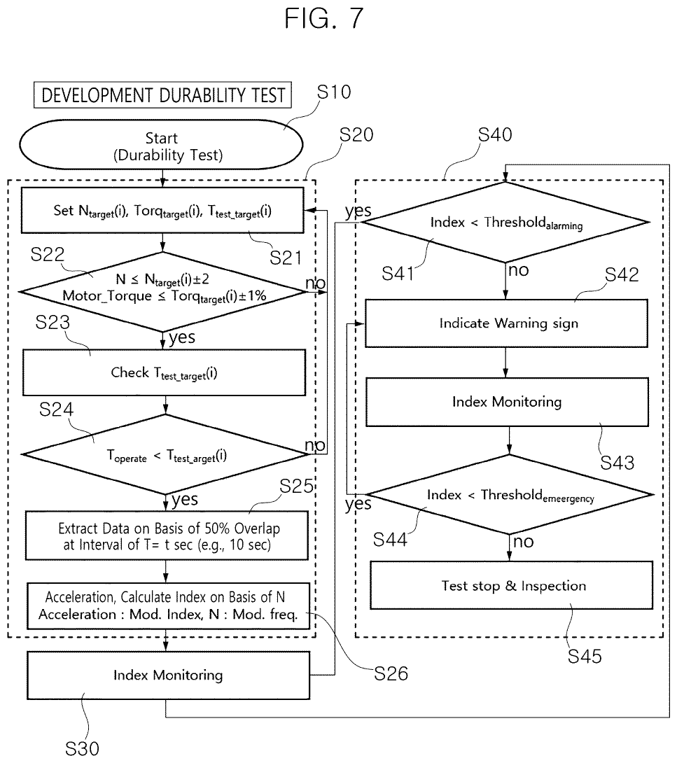

The development durability test for the electric powertrain (S10) calculates a variability-based index in a durability driving condition (S20), monitors an increase tendency of the calculated variability-based index according to a driving test cycle for a certain period of time (S30), and during the monitoring, classifies occurrence of flaking into a threshold (S40), and when the threshold exceeds a predetermined threshold, analyzes the electric powertrain through a durability test stop and inspection (S45) (see FIG. 7).

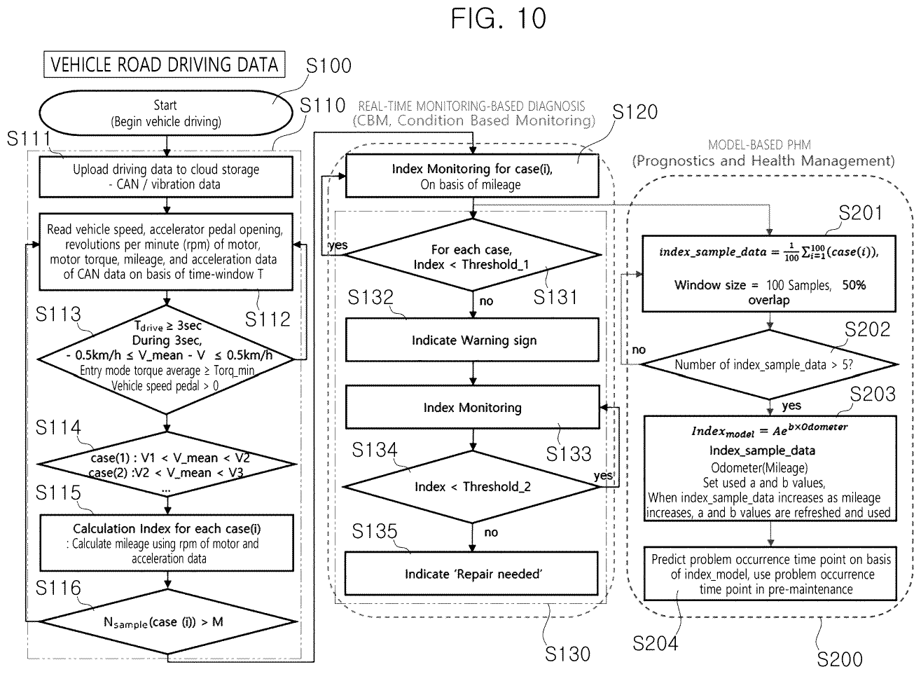

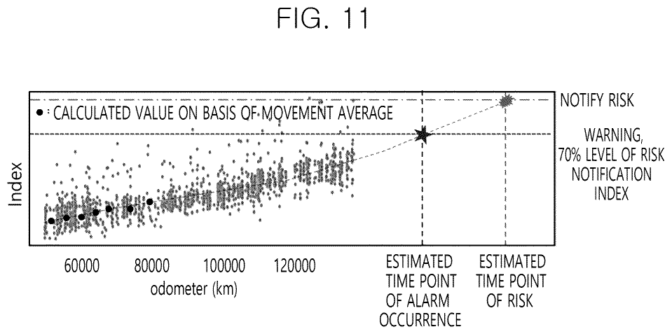

The actual road driving test of the electric powertrain (S100) is used for a variability-based index calculation in a constant speed condition (S110), a constant speed driving monitoring (S120) on a change of the calculated variability-based index in the constant speed condition on the basis of a mileage during the vehicle travels, a real-time monitoring-based diagnosis (condition based monitoring (CBM)) (S130) which reports bearing flaking for the electric powertrain by applying thresholds 1 and 2 to the index change (or index movement average) based on the mileage on the basis of the result of the constant speed driving monitoring (S120), and a model-based prognostics and health (S200) which predicts and diagnoses a future occurrence time of the bearing flaking for the electric powertrain by applying an index model (see FIG. 10).

The electric powertrain is an electric vehicle powertrain (ePT).

Referring to an electric powertrain 1 in FIG. 2, the electric powertrain 1 is a motor power transmission system of an electric vehicle and includes a driving motor 3 for generating a driving force using power stored in a battery, and a reducer 4 for transmitting a rotation of the driving motor 3 to a differential gear assembly as power and converting the rotation into a rotation speed of a vehicle driving shaft, and the reducer 4 is provided with a reduction gear and an output shaft together with an input shaft in order to transmit the power to the differential gear assembly.

In particular, although flaking occurs in the reducer 4, a bearing 5 is applied to the reducer 4 to support the input shaft, and the bearing 5 serves to fix the input shaft being rotating in a constant position and rotate the input shaft while supporting its own weight and a load applied to the input shaft. In this case, the bearing 5 may be a ball bearing.

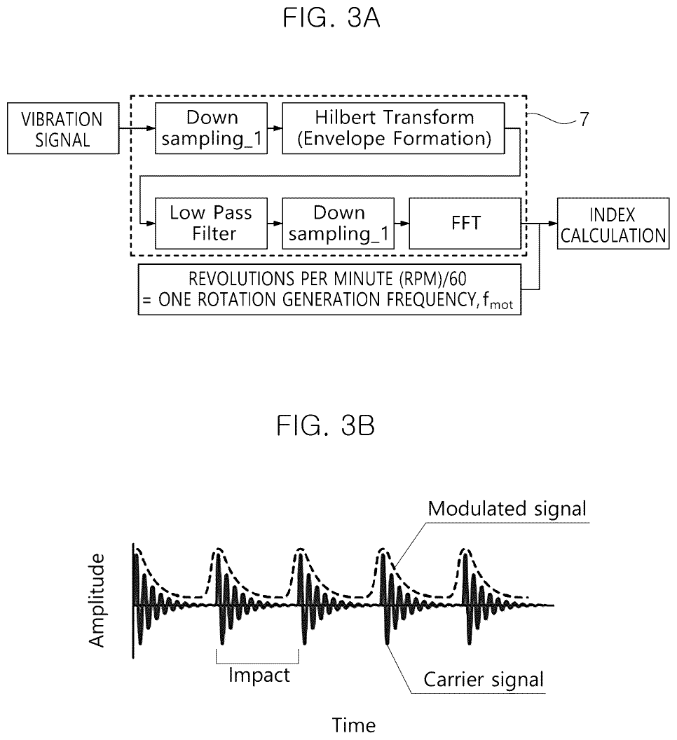

In addition, referring to the variability-based index calculation diagram 7 of FIG. 3A, the variability-based index calculation diagram 7 performs modulation analysis of a vibration according to the rotation using a vibration signal measured by an acceleration sensor (i.e., an acceleration sensor 8 in FIG. 9) mounted on the reducer 4 and revolutions per minute (RPM) signal of the motor of controller area network (CAN) data (i.e., the CAN 9 in FIG. 9) of the vehicle and performs the variability-based index calculation which determines whether flaking occurs in the bearing 5 mounted on the reducer 4.

As an example, the variability-based index calculation diagram 7 includes a first down sampling, a Hilbert transformation, a low-pass filter, a second down sampling, and a Fast Fourier transformation.

$$Index = \frac{1}{4} \text{?} Maximum ( Amplitud \text{?} ( \text{?} \times 0.9 {f}_{mot} \leq f \leq \text{?} \times 1.1 {f}_{mot} ) )$$

$$\text{?} \text{indicates text missing or illegible when filed}$$

The following equation is applied to the variability-based index.

FIG. 3B is a diagram illustrating a bearing impact as a modulated signal over time. “Amplitude” indicates a vibration magnitude of acceleration sensor 8 (see FIG. 9) according to a degree of acceleration of the motor, and fₘₒₜ indicates an excitation frequency (Hz) of the motor (e.g., N (RPM)/60).

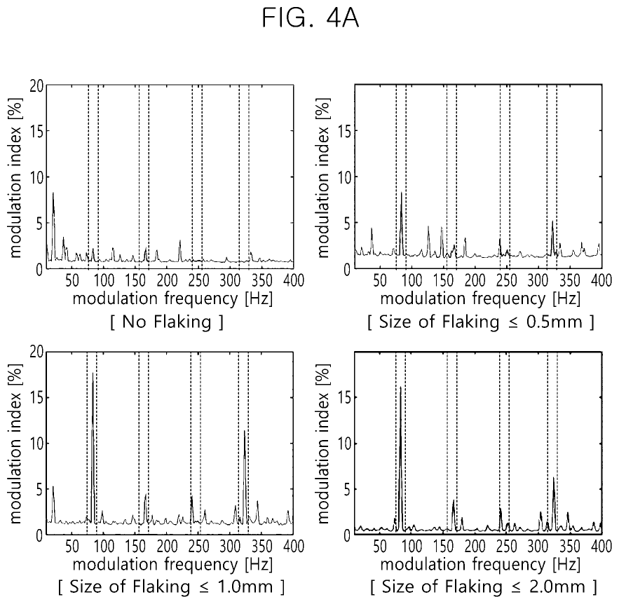

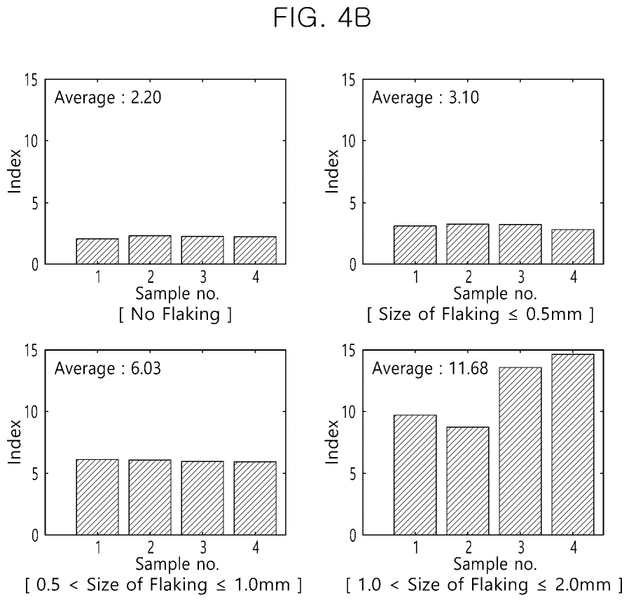

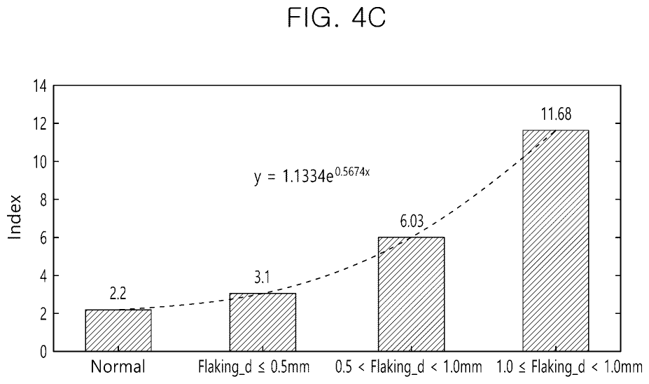

FIG. 4A is a graph related to an amplitude due to a bearing impact according to the modulation frequency. An x-axis of FIG. 4A is a modulation frequency (Mod. Freq.) and a y-axis thereof is a modulation index (%). As an example of a durability test driving condition for the driving motor 3 of the electric powertrain 1, when the RPM of the motor is 5,000 RPM and an excitation frequency is 83.3 Hz (=5000/60), an average of each maximum value is extracted from a modulation frequency section on the basis of first to four multiple frequencies±10%, that is, 83.3 Hz, 166.6 Hz, 250 Hz, and 333.3 Hz.

FIG. 4B shows an example of four flaking conditions including a normal (No Flaking), a first flaking size (Size of Flaking≤0.5 mm), a second flaking size (Size of Flaking≤1.0 mm), and a third flaking size (Size of Flaking≤2.0 mm) for the bearing 5.

In FIG. 4B, an x-axis is the sample number, and a y-axis is the variability-based index. The variability-based index is calculated for each sample from a graph of the modulation index (%) for the four samples, and then an average value for the four samples is calculated.

The calculation of the variability-based indexes (S2, S20, and S110) performed in the initial assembly inspection (S1), the development durability test (S10), and the actual road driving test (S100) for the electric powertrain 1 is performed through FIGS. 3 and 4.

FIG. 4C shows the driving motor of the average value of the variability-based index for the four samples according to four flaking conditions, and it can be seen that the average value of the variability-based index increases exponentially as flaking progresses.

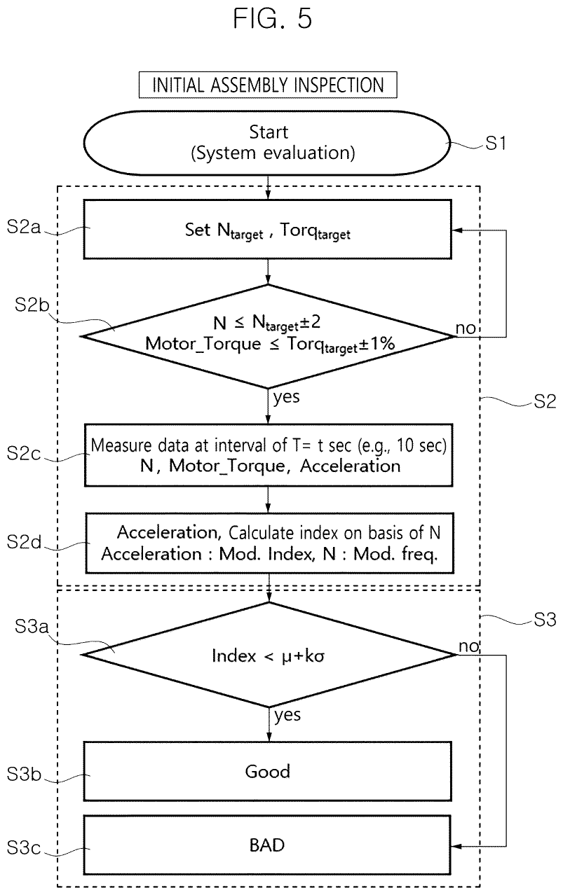

Hereinafter, the method of diagnosing bearing flaking of a vehicle and predicting remaining lifetime will be described in detail with reference to FIGS. 5 to 11, N_{target}, N_mot, Torq_{target}, and Motor_Torque, which are applied to the method, are terms for distinguishing N (an RPM of the motor or an RPM of the motor driving shaft) from Torque (motor torque), which are applied to the driving motor 3 of the electric powertrain 1 (see FIG. 2), and Acceleration refers to vibration data, which is a vibration amplitude of the vibration signal measured by the acceleration sensor 8 (see FIG. 9) applied to the reducer 4 of the electric powertrain 1.

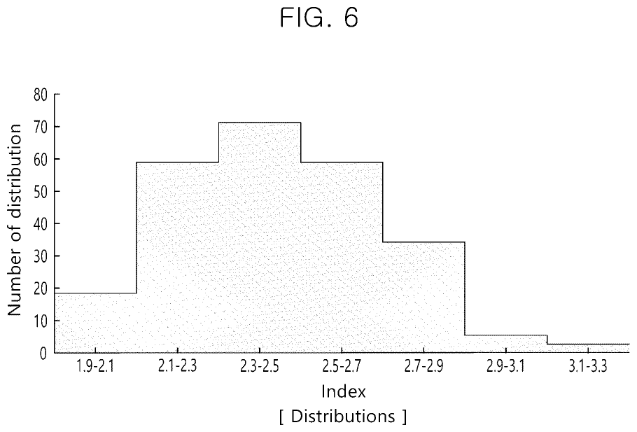

As one example, FIGS. 5 and 6 show a detailed example of the initial assembly inspection (S1) of the electric powertrain 1.

Referring to FIG. 5, the initial assembly inspection (S1) of the electric powertrain 1 is an initial assembly inspection (End Of Line Inspection) of the reducer at the factory, and a test condition for product performance inspection for the electric powertrain 1 is applied as an operating condition.

Therefore, in the test condition for assembly performance inspection of the electric powertrain 1, the variability-based index calculation (S2) includes an operation of setting measurement data (S2a), an operation of applying a measurement data acquisition condition (S2b), an operation of applying a data measurement time (S2c), and an operation of calculating the index (S2d).

As one example, in the setting of the measurement data (S2a), a target RPM N_{target} and a target torque Torq_{target} is applied, and in the applying of the measurement data acquisition condition (S2b) and the applying of the data measurement time (S2c), the following condition is applied to the driving motor 3 of the electric powertrain 1 (see FIG. 2). In this case, the measured data includes N (an RPM of the motor), Torque (a motor torque), and Acceleration (vibration data).
Measurement data acquisition condition: N≤N_{target}±2, Motor_Torque≤Torq_{target}±1%
Data measurement time: T=t seconds (e.g., t=10 seconds)

Here, “N” is the RPM of the motor or the motor driving shaft (N_mot) generated in a test condition for testing product (electric powertrain) performance, and “Motor_Torque” is the torque (motor torque) generated in a test condition for the driving motor 3. Margins are applied to “N_{target}” and “Torq_{target}”, “N_{target}” and “Torq_{target}” are a target RPM and a target torque applied to the test condition of the driving motor 3, and “T,t” is the measurement time. Here, ±2 and ±1% are only application examples and may be set to an arbitrary number or %, respectively.

In this way, the calculating of the index (S2d) is calculated from Acceleration (vibration data) measured according to the test condition of the initial assembly inspection (S1) and a modulation frequency Mod. Freq. for the excitation frequency (Hz) fₘₒₜ from the RPM of the motor N. The block diagram related to the index calculation has already been described in FIG. 3.

An operation of classifying the index distribution into good and bad (S3) is a process of using the index (S2d) as the index of the test condition and checking a degree of bearing flaking at the target RPM N_{target} and the target torque Torq_{target} (S2a) and includes an operation of determining an index distribution criterion problem (Index<μ+kσ) (S3a) and a good operation (S3b) or a bad operation (S3c).

From FIG. 6, a threshold for the determining of the index distribution criterion problem (S3a) is determined. FIG. 6 shows an index distribution state that is the result of the initial assembly inspection, an x-axis is the variability-based index (Index) and a y-axis is a distribution (Number of distribution). From the index distribution state, an average μ and a standard deviation σ are calculated, and a criterion for determining good (S3b) or bad (S3c) is adjusted according to a multiple of the standard deviation.

Index distribution criterion: Index of test condition<μ+kσ

Here, “μ+kσ” is an index criterion set value and may be expressed as “μ+N×σ.”

In this way, “μ+N×σ” is determined as an index distribution-based defective product diagnosis.

As a result, good (S3b) is when the index of the test condition is smaller than the index criterion set value (μ+kσ or μ+N×σ) (Yes), whereas, bad (S23c) is when the index of the test condition is greater than the index criterion set value (μ+kσ or μ+N×σ) (No). In this case, in bad (S23c), a cause is checked by performing disassembly and inspection on the electric powertrain 1 (see FIG. 2).

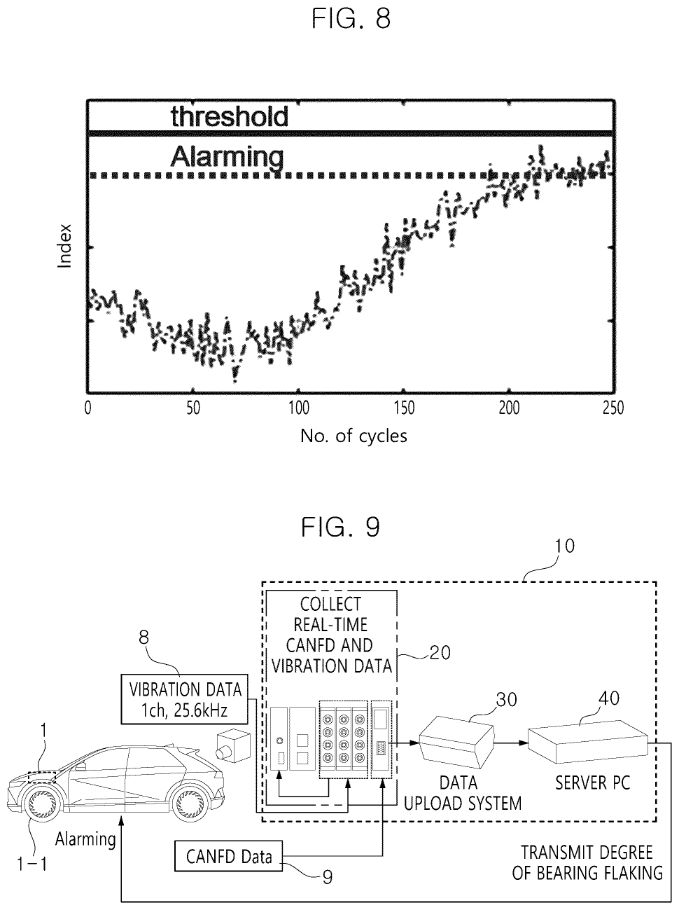

FIGS. 7 and 8 show a detailed example of the development durability test of the electric powertrain (S10).

Referring to FIG. 7, in the development durability test of the electric powertrain (S10), a durability test of the electric powertrain is performed, and an operating condition for the development durability test, which is defined by the RPM and the torque of the driving motor, is applied.

In the operating condition of the durability test, the variability-based index calculation (S20) includes an operation of setting durability test data (S21), an operation of applying a test data acquisition condition (S22), an operation of checking a test torque (S23), an operating of determining appropriateness of a test torque (S24), an operation of extracting a criterion measurement data (S25), and an operation of calculating an index (S26). In this case, “(i)” means the number of times.

As one example, in the setting of the durability test data (S21), a target RPM N_{target} (i), a target torque Torq_{target} (i), and a test target time T_{test_target}(i) for a specific number of times (i). In this case, “N_{target}(i) and Torq_{target}(i)” are the target RPM and the target torque applied to a durability operating condition of the driving motor 3, and “T_{test_target}(i)” is a driving time of the motor.

In addition, the following conditions are applied to the applying of the test data acquisition condition (S22), the checking of the test torque (S23), the determining of appropriateness of the test torque (S24), and the extracting of the criterion measurement data (S25).
Test data acquisition condition: N≤N_{target} (i)±2, Motor_Torque≤Torq_{target}(i)±1%
Test target time: T_{test_target}(i)
Target time appropriateness condition: Tₒₚₑᵣₐₜₑ<T_{test_target} (i)
Criterion measurement data extraction condition: T=t seconds (e.g., t=10 seconds) interval and Overlap 50%

Here, “Tₒₚₑᵣₐₜₑ” denotes an operating time in a durability operating condition, “T” denotes a measurement time, and “Overlap” denotes a degree of overlap of measurement data between time intervals. On the basis of these conditions, data for calculating a variability-based index is extracted. Here, ±2 and ±1% are only application examples and may be set to an arbitrary number or %, respectively.

In this way, the calculating of the index (S26) is calculated from Acceleration (vibration data) measured according to the operating condition of the development durability test (S10) and a modulation frequency Mod. Freq. for the excitation frequency (Hz) fₘₒₜ from the RPM of the motor N. The block diagram related to the index calculation has already been described in FIG. 3.

According to the above description, the calculating of the variability-based index is performed in the durability test, and the index may be calculated by changing the operating condition according to (i).

In the classifying of the index threshold (S40), an occurrence of bearing flaking may be checked with the calculated index (or index average), the classifying of the index threshold (S40) includes an operation of predicting flaking occurrence (S41), an operation of generating a bearing warning (indicate a warning sign) (S42), an operation of continuing cycle monitoring (index monitoring) (S43), an operation of checking flaking occurrence (S44), and an operation of stopping a cycle (S45).

As one example, the following conditions are applied to the predicting of the flaking occurrence (S41) and the checking of the flaking occurrence (S44).
Flaking occurrence prediction condition: Index<Threshold_{alarming}
Flaking occurrence confirmation condition: Index<Threshold_{emergency}

Here, “Index” is the calculated index (or index average) (S26), “Threshold_{alarming}” is an index alarm threshold, and “Threshold_{emergency}” is an index emergency threshold.

As a result, when the index (or index average) (S26) calculated according to a cycle repetition during the durability operating monitoring (S30) is greater than “Threshold_{alarming}” (No) that is the threshold of the predicting of the flaking occurrence (S41) of the bearing 5 on the reducer 4, an indication warning sign is generated in the generating of the bearing warning (S42).

In addition, the index (or index average) (S26) calculated according to the cycle repetition during the durability operating monitoring (S30) of the continuing cycle monitoring (S43) is greater than “Threshold_{emergency}” (No) that is the threshold of the checking of the flaking occurrence (S44) of the bearing 5 on the reducer 4, the stopping of the cycle (S45) is switched to a test stop and inspection.

FIG. 8 shows an index increase trend state that is a development durability test result, and it can be seen that, as the number of cycles increases and flaking progresses, the variability-based index increases exponentially.

That is, in order for a product (electric powertrain) performance test, the RPM of the motor and a reducer vibration value (e.g., one-axis vibration (vertical direction) of a reducer housing surface) are stored from the operating condition of the durability test defined by the RPM and the torque of the motor, and indexes for the RPM and the reducer vibration value represent results calculated through the variability-based index calculation diagram 7 and the variability-based index equation of FIG. 3 on the basis of Acceleration (vibration data) and the RPM (N) of the motor.

FIGS. 9 to 11 show a specific example of the actual road driving test of the electric powertrain (S100).

Referring to FIG. 9, a vehicle 1-1 (i.e., an electric vehicle) provides a bearing flaking detection system 10 with vibration data and data of the CAN 9 (e.g., a vehicle speed, an accelerator pedal depression degree (APS), an RPM, a motor torque, a mileage, and acceleration) from the acceleration sensor 8 mounted on the reducer 4 (see FIG. 2). Here, the acceleration sensor measures acceleration in the vertical direction, which is one-axis vibration of the reducer housing surface.

The bearing flaking detection system 10 determines whether flaking of the bearing occurs through vibration modulation analysis according to a rotation using the RPM of the motor and provides the determination result to the vehicle 1-1 through a wireless network.

The bearing flaking detection system 10 includes a data collector 20 for collecting the vibration data and the CAN data in real time and a data upload system 30 for uploading the CAN data and the vibration data, which are transmitted to the data collector 20, to a server computer 40, and the server computer 40 that calculates and determines a diagnosis result and a lifetime prediction result for whether flaking occurs in the bearing 5 and communicates with the vehicle 1-1 through a wireless network. The data collector 20 and the data upload system 30 are physically integrated, installed in the vehicle 1-1, and linked to the acceleration sensor 8 and the CAN 9 and may transmit the CAN data and the vibration data through a wireless network.

The bearing flaking detection system 10 may use the calculated variability-based index, which may monitor the degree of flaking occurrence, as a judder index. Judder refers to a phenomenon in which a vehicle body vibrates when a brake is stepped on or a brake pedal vibrates back and forth, making it rattle.

In particular, the bearing flaking detection system 10 monitors a change as a mileage of the vehicle increases to determine whether flaking occurs in the bearing 5 and may predict a current degree of flaking through a proposed judder index value (or a variability-based index) and predict an effective lifetime through monitoring the mileage.

As one example, on the basis of the vehicle speed V of 7 km/h, a constant speed driving condition extracted from the actual road driving data of the vehicle 1-1 is defined as “T_{drive}≥3 sec,” “0.5 km/h≤V_mean,” “V≤0.5 km/h,” “Accelerator pedal>0,” “section frequency≥N_{number} (e.g., 2000),” and “entry mode (i.e. constant speed driving condition) torque average≥Torq_min (e.g., 40 Nm), and “T_{drive}” denotes a constant speed driving time, “V_mean” denotes an average vehicle speed, “V” denotes a vehicle speed, “Accelerator Pedal” denotes an accelerator pedal stroke, “N” denotes an RPM of the motor, “Torq_min” denotes a minimum motor torque, and “section frequency N_{number}” denotes the number of times the vehicle travels in the constant speed driving condition at the torque average for each driving section.

Since the vehicle speed V is measured in a plurality of areas as V1, . . . , and Vn in S114 of FIG. 10, the vehicle speed V of 7 km/h is only an example of the constant speed driving, and a higher vehicle speed V may be applied.

For example, (1) vibration modulation analysis and index calculation during the constant speed driving, (2) change trend confirmation according to an increase in mileage on the basis of the calculated index, and (3) setting thresholds 1 and 2 for determining a bearing state according to the index are applied as a bearing flaking analysis method.

Referring to FIG. 10, after the actual road driving test of the electric powertrain is started (S100), vehicle data is measured during driving on the actual road, and a constant speed condition is determined. Here, the constant speed condition actually means a vehicle speed condition variable within a predetermined range, and thus it is strictly a quasi-constant speed condition.

First, CAN data and vibration data are acquired according to the vehicle driving in S111, and data is read from the server using a time-window reading method in which data is acquired on the basis of a time from a vehicle speed, an APS, an RPM of the motor, a motor torque (indicated torque), a mileage of the vehicle, and vibration data of the CAN data in S112.

S113 is an operation of determining whether the vehicle travels at a constant speed from the read data of S112.

For example, when a vehicle speed V and a motor torque motor_torque meet 0.5 km/h≤V_mean, V≤0.5 km/h, entry mode torque average≥Torq_min, and vehicle speed pedal>0 for three seconds of data extracted at a constant speed driving time T_{drive} in a constant speed driving time of T_{drive}≥3 sec and an extraction data condition of three seconds or more.

When the constant speed driving is determined, in S114, the average vehicle speed V_mean is divided into average vehicle speed cases (i) for sections of consecutive vehicle speeds V1, V2, . . . , and Vi. That is, S114 is an operation of dividing the vehicle speed section in which the constant speed driving is performed.

Meanwhile, the following conditions are applied to the constant speed driving vehicle speed section division (S114).

### Constant Speed Driving Vehicle Speed Section

Case 1: V1<V_mean<V2, Case 2: V2<V_mean<V3, . . . , and Case n: Vn−1<V_mean<Vn

Here, the “vehicle speed pedal” is the APS, and “V1, V2, V3, V4, . . . , and Vn” are vehicle speeds increasing continuously as V1 and V2, and V2 and V3 for the constant speed operation and increase in the order of V1<V2<V3<V4<, . . . , and <Vn.

As in the previous initial assembly inspection and development durability test, index calculation (S115) is performed for a mileage for case (1), . . . , and case (i) in the constant speed driving vehicle speed section from the RPM of the motor and the vibration data of the acceleration sensor.

That is, S115 is an operation of calculating a variability-based index for each of case (1), case (2), . . . , and case (i). In this case, each constant speed driving vehicle speed section case (i) is automatically stored in a sample dataset server for a corresponding condition.

Index calculation (S115) is performed through calculation of the variability-based index (modulation index) (see FIG. 3) calculated from the RPM of the motor and the acceleration data (i.e., a vibration value or the modulation frequency in the constant speed driving condition) for a mileage for each of case (1), case (2), . . . , and case (i) in the constant speed driving vehicle speed section.

S116 is an operation of checking the number of sample data stored for each case (i) in the constant speed driving vehicle speed section for the mileage. After the number of data samples is checked as 100 or more, such as “Nₛₐₘₚₗₑ (case (i))>100,” and when the number of sample data does not exceed 100, the process returns to S112, and when the number of sample data exceeds 100, the process enters S120. That is, when the number of sample data in the constant speed driving vehicle speed section corresponding to case (1) for the mileage is 100, the process proceeds from S116 to S120.

S120 is an operation of monitoring the variability-based index for each constant-speed driving vehicle speed section case (i) on the basis of the mileage.

In S120, since the number of data for each of case (1), case (2), . . . , and case (i) in the constant speed driving vehicle speed section is 100, index values for each constant speed driving vehicle speed condition Vi<V_mean<Vi+1 of case (i) are calculated as 100 numbers of values in the constant speed driving vehicle speed condition of case (1) (V1<V_mean<V2). The results are respectively used in the real-time monitoring-based diagnosis (S130) and the model-based prognostics and health (S200).

The real-time monitoring-based diagnosis (S130) is an operation of predicting flaking occurrence on the basis of the mileage and dividing confirmation of the flaking occurrence on the basis of the mileage into the thresholds 1 and 2 for the index and includes an operation of predicting the flaking occurrence on the basis of the mileage (S131), an operation of performing a bearing alarm (S132), an operation of continuing a mileage-based monitoring (S133), an operation of checking flaking occurrence on the basis of the mileage (S134), and an operating of performing bearing warning (S135). In this case, the bearing alarming (S132) and the bearing warning (S135) are displayed as a text in a cluster in a driver's seat of the vehicle 1-1.

When the variability-based index for each case (i) in the constant speed driving section in S120 is greater than the threshold 1 (Index<Threshold_1), the mileage-based flaking occurrence prediction (S131) generates a warning sign in S132.

When the threshold is greater than 2 or more (Index<Threshold_2) again in S134 after the index monitoring S133, a maintenance indication (indicating “Repair needed”) is generated in S135.

The bearing warning in S135 means that the electric powertrain 1 (see FIG. 2) needs to be disassembled and inspected through the maintenance indication.

Meanwhile, a case proceeding from S120 to S200 (prognostics and health management) will be described.

In S120, the number of sample data for each of a constant speed driving vehicle speed condition (V1<V_mean<V2), . . . , a constant speed driving condition (Vi<V_mean<Vi+1) in case (i) is M (e.g., M=100).

When a 50% overlap is present between the M pieces of sample data, S201 is an operation of calculating an index obtained by averaging the M pieces of sample data and calculating a sample data index index_sample_data for a case of the constant speed driving vehicle speed condition.

$$index\_sample \_data = \frac{1}{M} {\sum }_{i = 1}^{M} ( case ( i ) )$$

In S201, until the number of sample data indexes calculated reaching the constant speed driving vehicle speed condition cases 1, . . . , and i for case (1) to case (i) becomes 5, the sample data index is calculated by changing the constant speed driving vehicle speed condition cases. Here, 5 is merely an example.

When the number of index sample data calculated in S202 is 5, the process proceeds to S203.

In S203, a trend equation for a model index index_model may be calculated from the five sample data indexes index_sample_data and the mileage (Odometer) for the sample data.

The trend equation is Index_{model}=Ae_{b×Odometer}, and A and b may be calculated from several sample data indexes index_sample_data and the mileage (Odometer) for the sample data.

A and b of the model index Index_{model} may be updated or refreshed by a new sample data index new index_sample_data as the mileage (Odometer) increases.

Index prediction mode utilization (S204) checks a time point prediction when a criterion problem for flaking of the bearing 5 occurs and a bearing lifetime prediction for prior maintenance from the results derived from the index prediction model (S203). The server computer 40 transmits information on the time point prediction when the criterion problem for flaking of the bearing 5 occurs and the bearing lifetime prediction to the vehicle 1-1 through a wireless network, and thus the transmitted information is displayed as a text in the cluster of the driver's seat of the vehicle 1-1.

FIG. 11 is a diagram illustrating an example of the model-based prognosis/lifetime management (S200) using an index prediction model that shows an estimated status of a flaking occurrence time point of the bearing 5, which can be known from the index prediction model according to a data change of an index movement value.

As shown in the drawing, like an index-odometer diagram, the index function Index model of the index prediction model (S203) is set through curve fitting based on a time point when a trend of the measured value appears.

In particular, the index value used for the curve fitting is calculated with a 50% overlap of the movement average values of 100 window sizes.

Therefore, it can be seen that the index-odometer diagram, which is the index prediction model (S203), is capable of estimating the index according to the data change and the prediction model-based occurrence time point on the basis of a curve fitting function obtained on the basis of the data so that warning and an occurrence time point of a risk level may be predicted in advance.

For example, an index of a warning occurrence expectation time point is applied to the warning, and an index level of about 70% compared to an index of a risk expectation time point applied to the risk notification is applied to the index of a warning occurrence expectation time point.

As described above, in the method of diagnosing bearing flaking of the vehicle 1-1 and predicting remaining lifetime of according to the present embodiment, the index calculated through any one of the test condition of the initial assembly inspection (S1) of the electric powertrain 1, the operating condition of the development durability test (S10), and the constant speed condition of the actual road driving test (S100) is applied to the warnings of flaking the bearing 5 (S42 and S132), the inspection/repair (S45 and S135), and the occurrence time prediction (S204). Therefore, occurrence of flaking for the electric powertrain 1 may be prepared using any one of the disassembly inspection (S3c) in the initial assembly inspection (S1), the test stop and inspection (S45) in the development durability test (S10), and the repair (S135) or the prediction of occurrence time point (S204) in the actual road test (S100).

That is, the variability-based indexes according to the RPM of the motor and Amplitude from the acceleration sensor are acquired in advance in the test condition of the initial assembly inspection (S1) of the electric powertrain 1 or the operating condition of the development durability test (S10), the constant speed condition of the actual road driving test (S100) may be performed. In addition, before the constant speed condition of the actual road driving test (S100), the variability-based index may be acquired in a separate method different from the test condition of the initial assembly inspection (S1) or the operating condition of the development durability test (S10).

FIG. 11 is a diagram illustrating the index movement average value that is the result of a real road driving test that exemplifies that a modulation and an index are calculated on the basis of the RPM of the motor and a frequency of vibration in case (i) of the constant speed driving vehicle speed condition in which the constant speed (or quasi-constant speed) driving condition (an average vehicle speed allowable range of 7 km/h±0.5 km/h) is maintained for a certain period of time (about three seconds) while the mileage of the vehicle is increasing and exemplifies results of determining first and second movement average values for the index

From this, monitoring-based status diagnosis for the calculated index according to the increase in mileage on the basis of the actual road driving data is divided into a threshold 1 Threshold_1 of the first movement average value and a threshold 2 Threshold_2 of the second movement average value, and thus it can be seen that an index increase trend as a flaking size increases on the basis of the average values is exemplified from the index-average graph.

In accordance with a method of diagnosing bearing flaking and predicting a remaining lifetime according to the present disclosure, which is applied to a vehicle, it can be determined whether flaking occurs in a bearing on a reducer through analysis of a modulation of a vibration according to a rotation on the basis of a vibration signal measured from an acceleration sensor mounted on the reducer of an electric powertrain and a revolutions per minute (RPM) signal of a motor measured from a controller area network (CAN) of the vehicle.

Therefore, in accordance with the method of diagnosing bearing flaking and predicting a remaining lifetime, by detecting an occurrence of flaking and predicting a change in inner and outer rings of a ball bearing used in the reducer of the electric powertrain of an electric vehicle, it can address customer complaints when a vibration and a noise occur due to the occurrence of flaking that is a mechanical defect of the bearing. In particular, even when a mechanical defect occurs, limitations of the existing on board diagnostics (OBD) function, which cannot detect problems, can be overcome, major accidents caused by damage to mechanical elements due to a normal operation for a long period of time can be prevented in a state in which a mechanical defect occurs, and a flaking occurrence of the bearing assembled with inner and outer rings can be prevented from progressing to vehicle problems by increasing its size in a short period of time even when there are process defects in a new bearing product.

While the present disclosure has been described with reference to the accompanying drawings, it will be apparent to those skilled in the art that various changes and modifications can be made without departing from the spirit and scope of the present disclosure without being limited to the exemplary embodiments disclosed herein. Accordingly, it should be noted that such alternations or modifications fall within the claims of the present disclosure, and the scope of the present disclosure should be construed on the basis of the appended claims.

1. A method of diagnosing bearing flaking of a vehicle and predicting a remaining lifetime, the method comprising:
storing controller area network (CAN) data and vibration amplitude data from an acceleration sensor while a vehicle equipped with an electric powertrain with the acceleration sensor attached thereto is traveling;
extracting data from the CAN data according to an average vehicle speed corresponding to a constant speed driving during driving;
calculating a variability-based index for each constant speed driving vehicle speed section from revolutions per minute (RPM) of a motor and the vibration amplitude data based on a mileage; and
diagnosing a bearing flaking occurrence in real time using a first threshold and a second threshold for the variability-based index;
wherein the variability-based index is calculated using an equation related to an excitation frequency, which is one rotation frequency of the motor and the vibration amplitude data:
$$Index = \frac{1}{4} \text{?} Maximum ( Amplitud \text{?} ( \text{?} \times 0.9 {f}_{mot} \leq f \leq \text{?} \times 1.1 {f}_{mot} ) ) .$$
$$\text{?} \text{indicates text missing or illegible when filed}$$

2. The method of claim 1, wherein the CAN data includes one or more of a vehicle speed, an accelerator pedal depression, the RPM of the motor, a motor torque, the mileage, and acceleration data.

3. The method of claim 1, wherein:
in a constant speed driving, the average vehicle speed within a predetermined range is maintained during a constant speed driving time;
an indicated torque is greater than or equal to an entry mode minimum torque average;
a vehicle speed pedal depression (APS) is greater than zero; and
data is acquired as time-window reading.

4. The method of claim 3, further comprising:
when the constant speed driving corresponds to a constant speed, dividing the average vehicle speed is divided into average vehicle speed cases for sections of consecutive vehicle speeds; and
calculating the variability-based index for each of the average vehicle speed cases.

5. The method of claim 4, wherein the diagnosing of the bearing flaking occurrence in real time is performed when a number of average vehicle speed cases exceeds M.

6. The method of claim 4, wherein when a number of sample data for the constant speed operation vehicle speed condition case for each section of vehicle speeds exceeds M, the number of sample data is M from a constant speed driving vehicle speed condition case of V1<V_mean<V2 to a constant speed driving vehicle speed condition case of Vi<V_mean<Vi+1, and a 50% overlap is present between the sample data constituting the constant speed driving vehicle speed condition for each section of the vehicle speeds among M, and a sample data index for an average vehicle speed case for each section of the M vehicle speeds is
$$index\_sample \_data = \frac{1}{M} {\sum }_{i = 1}^{M} ( case ( i ) ) .$$

7. The method of claim 6, wherein a trend equation for a model index is able to be calculated from a plurality of sample data indexes and a mileage for the sample data.

8. The method of claim 7, wherein
the trend equation is Index_{model}=Ae^{b×Odometer}; and
A and b are calculated from the plurality of sample data indexes and the mileage for the sample data.

9. The method of claim 8, wherein A and b of a model index are updated or refreshed by a new sample data index as the mileage increases.

10. The method of claim 1, wherein:
in the first and second thresholds, a mileage-based flaking occurrence prediction and a mileage-based flaking occurrence confirmation are applied to the variability-based index;
when the first threshold is out of the mileage-based flaking occurrence prediction, an indicate warning sign for the flaking occurrence is generated in the vehicle; and
when the second threshold is out of the mileage-based flaking occurrence confirmation, an indicate repair sign for the electric powertrain is generated in the vehicle.

11. A method of diagnosing bearing flaking of a vehicle and predicting a remaining lifetime, the method comprising:
setting a target revolutions per minute (RPM) and a target torque for driving an electric powertrain during an initial assembly inspection of the electric powertrain with an acceleration sensor attached thereto;
when the RPM and the target torque for driving the electric powertrain are constant, measuring vibration amplitude data, the RPM, and the target torque from the acceleration sensor for a predetermined measurement time; and
calculating a variability-based index;
wherein the variability-based index is calculated using an equation related to an excitation frequency, which is one rotation frequency of the motor and the vibration amplitude data:
$$Index = \frac{1}{4} \text{?} Maximum ( Amplitud \text{?} ( \text{?} \times 0.9 {f}_{mot} \leq f \leq \text{?} \times 1.1 {f}_{mot} ) ) .$$
$$\text{?} \text{indicates text missing or illegible when filed}$$

12. The method of claim 11, wherein whether the target RPM and the target torque are constant is determined from a motor RPM using the target RPM and a motor torque using the target torque.

13. The method of claim 12, further comprising:
determining as good when the variability-based index is less than a predetermined value, and determining as bad when the variability-based index is greater than or equal to the more than the predetermined value; and
performing disassembly and inspection on the electric powertrain when determined as bad.

14. A method of diagnosing bearing flaking of a vehicle and predicting a remaining lifetime, the method comprising:
setting one or more of a target revolutions per minute (RPM), a target torque, and a target time in an initial endurance test of an electric powertrain with an acceleration sensor attached thereto;
when the target RPM and the target torque are constant,
checking the target time and confirming that an operating time is less than the target time;
extracting data with a 50% overlap at intervals of a predetermined measurement time; and
calculating a variability-based index from the extracted target RPM, the extracted target torque, and extracted vibration amplitude data;
wherein the variability-based index is calculated using an equation related to an excitation frequency, which is one rotation frequency of the motor and the vibration amplitude
$$Index = \frac{1}{4} \text{?} Maximum ( Amplitud \text{?} ( \text{?} \times 0.9 {f}_{mot} \leq f \leq \text{?} \times 1.1 {f}_{mot} ) ) .$$
$$\text{?} \text{indicates text missing or illegible when filed}$$

15. The method of claim 14, wherein whether the target RPM and the target torque are constant is determined from a motor RPM using the target RPM and a motor torque using the target torque.

16. The method of claim 15, further comprising:
providing an index alarm threshold to the variability-based index; and
when the variability-based index is out of the index alarm threshold, generating an indicate warning sign.

17. The method of claim 16, further comprising:
providing an index emergency threshold to the variability-based index; and
when the variability-based index is out of the index emergency threshold, performing a test stop and inspection.
